(19) United States
(12) Patent Application Publication
(10) Pub. No.: US 2020/0362589 A1
(43) Pub. Date: Nov. 19, 2020

(54) ILLUMINATED LOCK ASSEMBLY

(71) Applicant: Ford Global Technologies, LLC, Dearborn, MI (US)

(72) Inventors: Stuart C. Salter, White Lake, MI (US); Kent Harrison, Northville, MI (US); David Brian Glickman, Southfield, MI (US); Paul Kenneth Dellock, Northville, MI (US)

(73) Assignee: Ford Global Technologies, LLC, Dearborn, MI (US)

(21) Appl. No.: 16/410,477

(22) Filed: May 13, 2019

(51) Int. Cl. E05B 17/10; E05B 17/14; B60Q 3/80; B60Q 3/292; B60Q 3/267

(52) U.S. Cl. CPC E05B 17/10; E05B 17/142; E05B 17/106; B60Q 2500/00; B60Q 3/292; B60Q 3/267; B60Q 3/80

(57) ABSTRACT

A lock assembly for use in a vehicle includes a key having a key head and a key shaft. The key shaft defines a recess. A lock cylinder defines a slot and a channel. The slot is in communication with a first end of the channel. A switch door is positioned to cover the slot. A light source is positioned at a second end of the channel. The light source is positioned to illuminate through the channel. A sensor is configured to detect the key. The sensor is coupled with the light source. The sensor is configured to actuate the light source based on a location of the key. A luminescent structure is positioned on the key shaft within the recess.

### FIELD OF THE DISCLOSURE

The present disclosure generally relates to a lock assembly, and more specifically to an illuminated lock assembly for use within a vehicle.

### BACKGROUND OF THE DISCLOSURE

Illumination arising from the use of photoluminescent structures and corresponding light sources offers a unique and attractive viewing experience as well as improved visibility of certain features. It is therefore desired to implement such structures in automotive vehicles for various lighting applications.

### SUMMARY OF THE DISCLOSURE

According to one aspect of the present disclosure, a lock assembly for use in a vehicle includes a key having a key head and a key shaft. The key shaft defines a recess. A lock cylinder defines a slot and a channel. The slot is in communication with a first end of the channel. A switch door is positioned to cover the slot. A light source is positioned at a second end of the channel. The light source is positioned to illuminate through the channel. A sensor is configured to detect the key. The sensor is coupled with the light source. The sensor is configured to actuate the light source based on a location of the key. A luminescent structure is positioned on the key shaft within the recess.

Embodiments of this aspect of the disclosure can include any one or a combination of the following features:
the switch door being at least partially translucent;
the luminescent structure being positioned on an edge of the key shaft;
the light source being configured to emit light at one or more intensities in response to activation of the sensor; and/or
the luminescent structure being configured to luminesce in response to excitation by the light source.

According to another aspect of the present disclosure, a lock assembly includes a lock cylinder operably coupled with a vehicle and defining a channel. The channel has an open first end. A key is configured to be at least partially received by the channel. A light source is positioned at a second end of the channel. The second end is opposite the first end. The light source is configured to illuminate through the channel. A sensor is coupled with the light source and configured to actuate the light source based on a location of the key. A luminescent structure is positioned on the key. The luminescent structure is configured to luminesce in response to excitation by the light source.

Embodiments of this aspect of the disclosure can include any one or a combination of the following features:
the key including a key shaft defining a recess, wherein the luminescent structure is positioned within the recess;
the key including indicia, wherein the luminescent structure is positioned on the indicia;
the lock assembly further including a switch door positioned over the first end of the channel;
the lock cylinder being operably coupled with an ignition switch;
the lock cylinder being operably coupled with an exterior door of the vehicle;
the sensor being configured to increase illumination of the light source as the key is moved proximate the lock cylinder; and/or
the luminescent structure being pad printed onto the key.

According to another aspect of the present disclosure, a lock assembly includes a key defining a recess and a lock cylinder operably coupled with a vehicle. The lock cylinder defines a channel having first and second ends. The channel is configured to at least partially receive the key. A light source is positioned at an end of the channel and configured to illuminate through the channel. A sensor is configured to detect the key. The sensor is configured to actuate the light source based on a location of the key.

Embodiments of this aspect of the disclosure can include any one or a combination of the following features:
the lock assembly further including a switch door positioned over the first end of the channel, the first end opposite the second end of the channel;
a switch door being translucent, wherein excitation light from the light source is directed through the switch door;
the lock assembly further including a luminescent structure positioned with the recess of the key, the luminescent structure configured to luminesce in response to excitation by the light source;
the key including indicia, and further wherein a luminescent structure is positioned on the indicia;
the light source is configured to emit light at one or more intensities in response to activation of the sensor; and/or
an intensity is selected from the one or more intensities based on a distance between the key and the sensor.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1A is a side view of a photoluminescent structure rendered as a coating for use on a vehicle ignition key, according to some examples;

FIG. 1B is a top view of a photoluminescent structure rendered as a discrete particle according to one embodiment;

FIG. 1C is a side view of a plurality of photoluminescent structures rendered as discrete particles and incorporated into a separate structure;

FIG. 2A is a side perspective view of a vehicle including an illuminated lock cylinder for use with an exterior door lock, according to some examples;

FIG. 2B is a front perspective view of a vehicle interior including an illuminated lock cylinder for use with a vehicle ignition switch, according to some examples;

FIG. 2C is a side perspective view of a vehicle interior including an illuminated lock cylinder for use with a vehicle ignition switch, according to some examples;

FIG. 3A is a side perspective view of a lock cylinder, according to various examples;

FIG. 3B is a side perspective view of a lock cylinder, according to various examples;

FIG. 4 is a side perspective view of a key including luminescent structures, according to some examples;

FIG. 5A is a perspective view of a lock assembly including the lock cylinder of FIG. 3 in an unilluminated state and the key of FIG. 4, according to some examples;

FIG. 5B is a perspective view of a lock assembly including the lock cylinder of FIG. 3 in an illuminated state and the key of FIG. 4, according to some examples;

FIG. 6A is a schematic diagram of a lock assembly coupled with an exterior door, according to various examples; and

FIG. 6B is a schematic diagram of a lock assembly coupled with an ignition switch, according to various examples.

### DETAILED DESCRIPTION OF THE PREFERRED EMBODIMENTS

The present illustrated embodiments reside primarily in combinations of method steps and apparatus components related to a lock assembly for use on a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

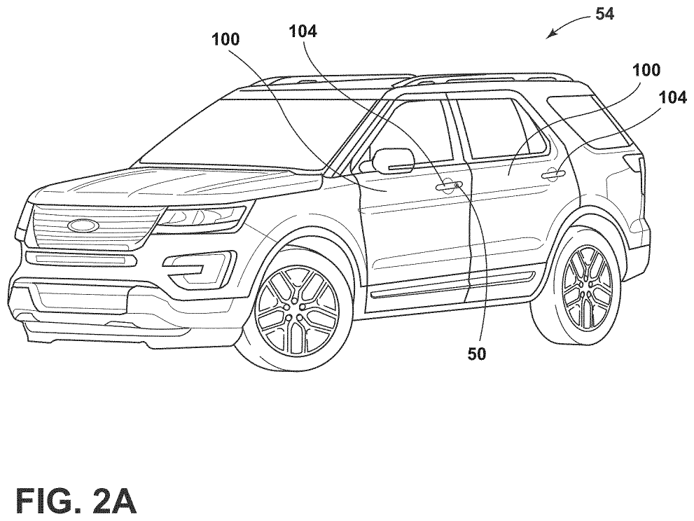

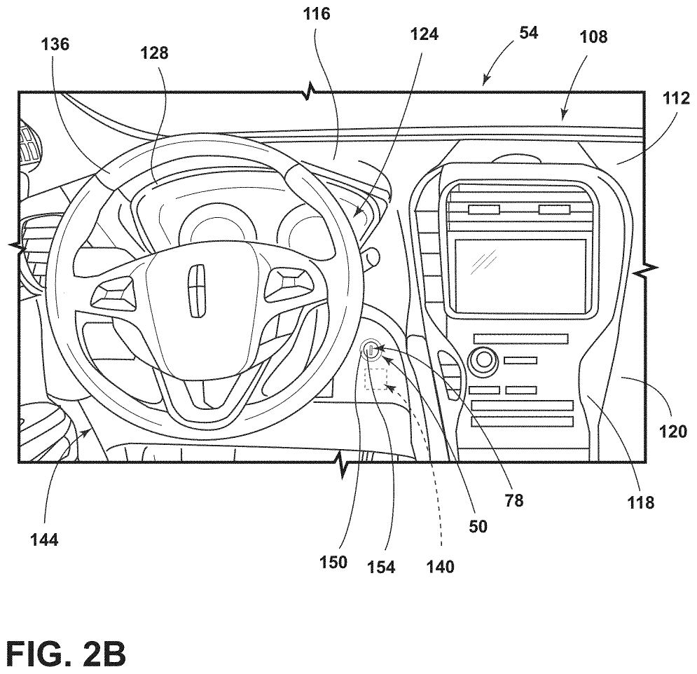

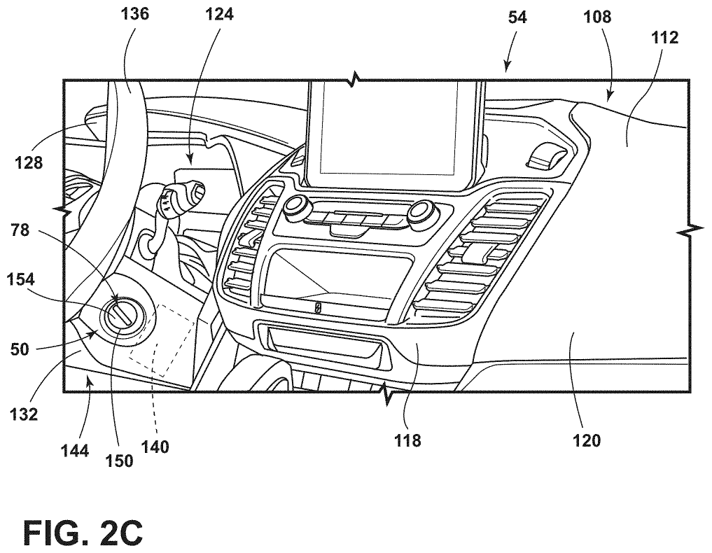

For purposes of description herein, the terms “upper,” “lower,” “right,” “left,” “rear,” “front,” “vertical,” “horizontal,” and derivatives thereof shall relate to the disclosure as oriented in FIGS. 2B and 2C. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

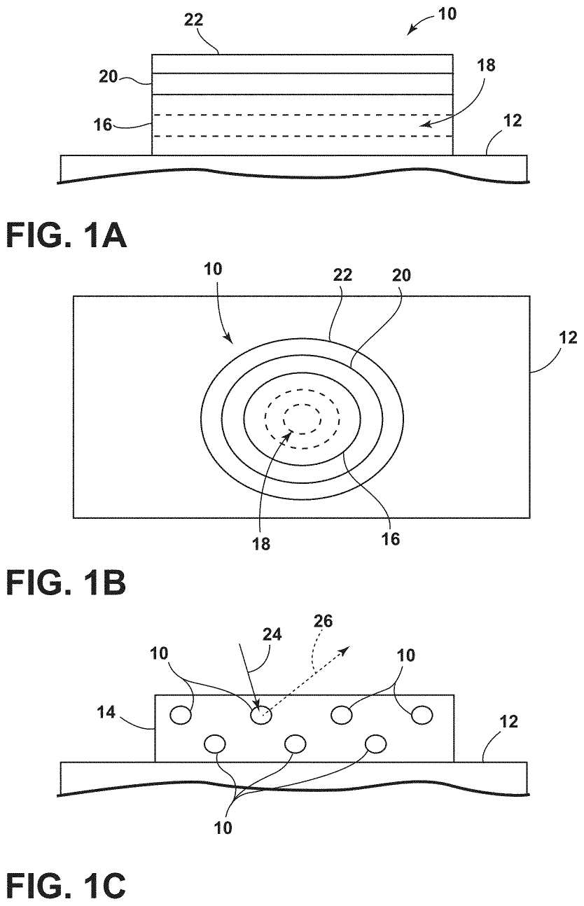

Referring to FIGS. 1A-1C, various examples of luminescent structures 10 are shown, each capable of being coupled to a substrate 12, which may correspond to a vehicle fixture or vehicle-related piece of equipment (e.g., a key 58). In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer-wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring again to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (i.e., 10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

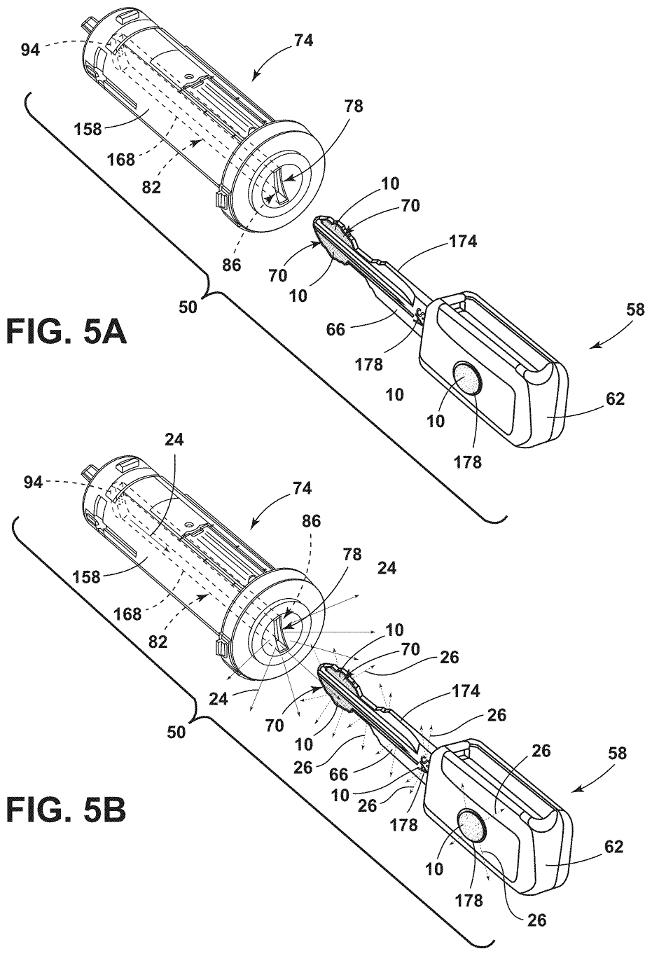

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue excitation light 24 emitted from one or more light sources (e.g., a light source 94 (FIGS. 5A and 5B)). According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material 18 known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light source (e.g., a light source 94 (FIGS. 5A and 5B)). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any one or more light sources (e.g., a light source 94 (FIGS. 5A and 5B)) that emit the excitation light 24, including, but not limited to, natural light sources (e.g., the sun) and/or any one or more artificial light sources (e.g., a light source 94 (FIGS. 5A and 5B)). The periodic absorption of the excitation light 24 from any excitation source may provide for a substantially sustained charge of the long-persistence luminescent material 18 to provide for consistent passive illumination.

The long-persistence luminescent material 18 may correspond to alkaline earth aluminates and silicates, for example, doped di-silicates, or any other compound that is capable of emitting light for a period of time once the excitation light 24 is no longer present. The long-persistence luminescent material 18 may be doped with one or more ions, which may correspond to rare earth elements, for example, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the excitation light 24 and d-d transitions of Mn2+ ions.

According to an alternate non-limiting example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Referring now to FIGS. 2A-6B, reference numeral 50 generally designates a lock assembly for use in a vehicle 54. The lock assembly 50 includes a key 58 having a key head 62 and a key shaft 66. The key shaft 66 may define a recess 70. A lock cylinder 74 may define a slot 78 and a channel 82. The slot 78 may be in communication with a first end 86 of the channel 82. A switch door 90 may be positioned to cover the slot 78. A light source 94 may be positioned at a second end 88 of the channel 82. The light source 94 may be configured to illuminate through the channel 82. A sensor 98 may be configured to detect the key 58. The sensor 98 may be coupled with the light source 94 and may be configured to actuate the light source 94 based on a location of the key 58. A luminescent structure 10 may be positioned on the key shaft 66 within the recess 70.

With reference now to FIGS. 2A-2C, the vehicle 54 is illustrated having a plurality of exterior doors 100. Each exterior door 100 includes a handle 104. A lock assembly 50 may be positioned proximate each handle 104, such that the lock assembly 50 acts as an exterior lock assembly 50 for the respective exterior door 100. The vehicle 54 further includes an interior cabin 108. An instrument panel 112 is disposed vehicle forward within the cabin 108 and extends cross-car within the cabin 108. The instrument panel 112 may include a driver-side portion 116, a center portion 118, and a passenger-side portion 120. As illustrated in FIG. 2C, the driver-side portion 116 of the instrument panel 112 includes an instrument cluster 124 covered by an instrument cluster hood 128. A steering column 132 is located below the instrument cluster 124. The steering column 132 is supported by the instrument panel 112 and engages a steering system (not shown) positioned vehicle forward of the instrument panel 112. The steering column 132 extends from the steering system into the cabin 108 through, or below, the instrument panel 112 and has a steering wheel 136 disposed at one end thereof.

Referring now to FIGS. 2B and 2C, an ignition switch 140 may be positioned within the cabin 108 proximate the steering column 132. In various examples, the ignition switch 140 may be positioned within the steering column 132 such that the ignition switch 140 is accessible from a side of the steering column 132 (FIG. 2C). In other examples, the ignition switch 140 may be positioned within the driver-side portion 116 of the instrument panel 112 (FIG. 2B), within the center portion 118 of the instrument panel 112, or within any portion of the cabin 108 accessible from a driver's region 144 of the cabin 108.

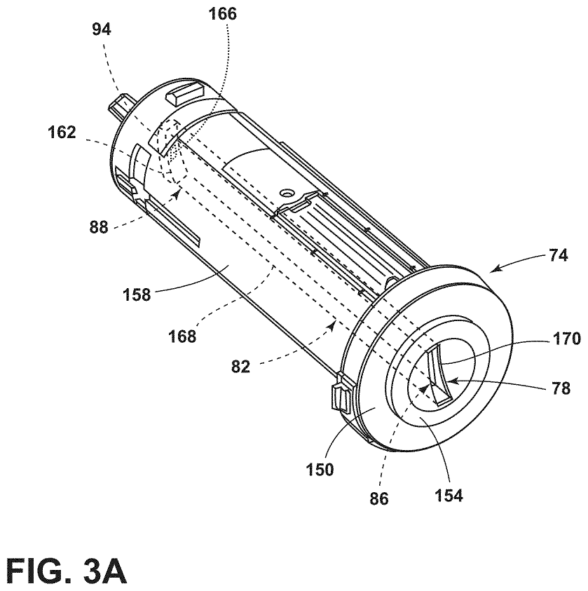

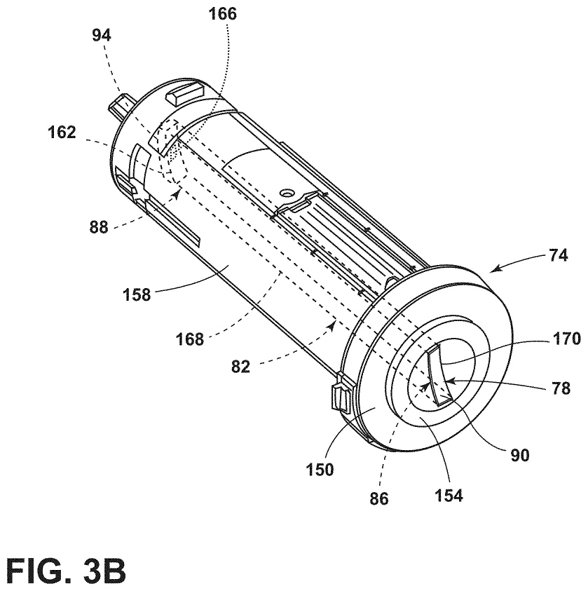

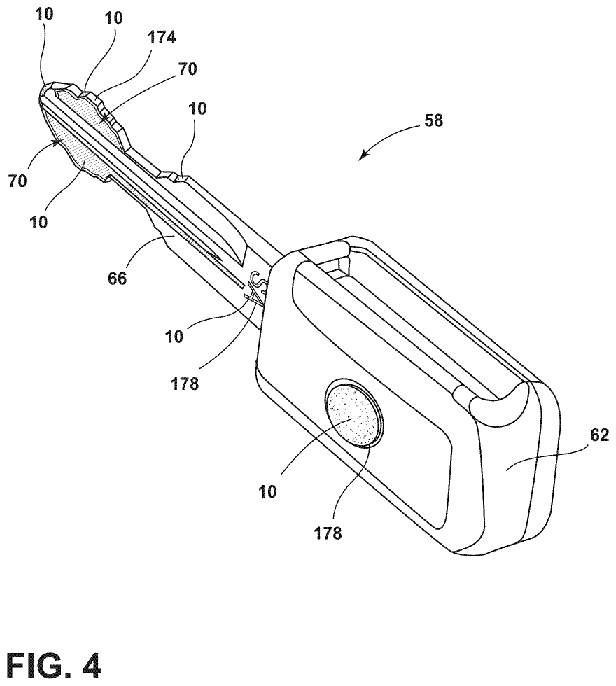

Referring now to FIGS. 2A-3B, the lock assembly 50 includes the lock cylinder 74 having an outer rim 150 extending circumferentially from an end face 154 of the lock cylinder 74. The end face 154 may be integrally formed with a body 158 of the lock cylinder 74 and may be positioned exterior of the lock cylinder 74 such that the end face 154 is accessible when the lock cylinder 74 is installed. The body 158 of the lock cylinder 74 may be generally cylindrical. When the lock cylinder 74 is installed, the body 158 may be substantially hidden. The end face 154 may be generally circular to complement the cross-sectional shape of the body 158. Similarly, the outer rim 150 may be generally circular to complement the shape of the end face 154. However, it will be understood that the end face 154 and/or the outer rim 150 may be any shape without departing from the scope of the present disclosure. Furthermore, the end face 154 may be generally concave, or the end face 154 may be generally planar. Where the end face 154 is concave, the concavity of the end face 154 may be selected to guide engagement of the key 58 with the lock cylinder 74.

The body 158 of the lock cylinder 74 may be configured to be coupled to a latch mechanism, ignition switch 140, or any other device useable with a lock assembly 50 without departing from the scope of the present disclosure. For example, the lock assembly 50 may be used with one or more of the exterior doors 100 and may be operably coupled with the locking mechanism of the exterior door 100. In another example, the lock assembly 50 may be operably coupled with the ignition switch 140 of the vehicle 54. When the lock assembly 50 is installed, the outer rim 150 of the lock cylinder 74 may be positioned substantially flush with an outer surface of the exterior door 100, the instrument panel 112, or the steering column 132. It will be understood that the lock assembly 50 may be used in or on any part of the vehicle 54 (e.g., a trunk door, a glove box, etc.) without departing from the scope of the present disclosure.

Referring now to FIGS. 3A and 3B, the channel 82 may be defined extending at least partially along a length of the body 158 of the lock cylinder 74. The channel 82 may be generally defined by a channel wall 168. In various examples, the channel wall 168 may be continuous. In other examples, the channel wall 168 may include gaps for receiving locking components. The channel wall 168 may be defined by the lock cylinder 74 and may be generally metallic, as discussed elsewhere herein. Alternatively, the channel wall 168 may be defined by a light guide 170, as discussed elsewhere herein.

The channel 82 may extend from the end face 154 of the lock cylinder 74 toward an opposite end of the lock cylinder 74. In various examples, the channel 82 may have a generally rectangular cross-sectional shape. In other examples, the channel 82 may have a generally round, oblong, triangular, square, or any other polygonal cross-sectional shape without departing from the scope of the present disclosure. As introduced previously, the channel 82 may further have the first end 86 defined by the end face 154 of the lock cylinder 74. The first end 86 may be open and may be in communication with the slot 78. The slot 78 may be defined by the end face 154 of the lock cylinder 74. In the illustrated example in FIGS. 3A and 3B, the slot 78 is generally rectangular. However, the slot 78 is sized to correspond with the cross-sectional shape of the channel 82. The slot 78 and the channel 82 are of a shape and size to at least partially receive the key shaft 66 of the key 58, as discussed elsewhere herein.

The channel 82 may further include a second end 88. The second end 88 may be positioned interior of the first end 86 of the channel 82. The second end 88 is positioned opposite the first end 86 of the channel 82 and may be configured to have the same cross-section as the first end 86 and the channel 82. The second end 88 may terminate in an inner end wall 162 within the lock cylinder 74. The inner end wall 162 may be integrally formed with the channel wall 168. Alternatively, the inner end wall 162 may be operably coupled with the channel wall 168. The inner end wall 162 may be generally transparent to allow excitation light 24 to transmit through the inner end wall 162. Alternatively, the inner end wall 162 may be at least partially opaque or semi-transparent to guide the excitation light 24 through the channel 82.

The inner end wall 162 may define an opening 166. In various examples, the opening 166 may be shaped to complement the cross-sectional shape of the channel 82. In other examples, the opening 166 may be of a shape and size to at least partially receive the light source 94, as discussed below. Where the opening 166 at least partially receives the light source 94, the light source 94 may extend at least partially into the channel 82 toward the first end 86. In still other examples, the light source 94 may be positioned within the second end 88 of the channel 82 such that the light source 94 directly fills the second end 88 of the channel 82.

The light source 94 may be positioned at the second end 88 of the channel 82, as discussed above. The light source 94 may include one or more individual light sources 94. The light sources 94 may be fluorescent lights, light emitting diodes (LEDs), organic LEDs (OLEDs), polymer LEDs (PLEDs), solid-state lighting, or any other form of lighting configured to emit light, without departing from the scope of the present disclosure. The light source 94 may be configured to emit a wavelength of excitation light 24 that is characterized as ultraviolet (UV) light (˜10-400 nanometers in wavelength), violet light (˜380-450 nanometers (nm) in wavelength), blue light (˜450-495 nanometers in wavelength), and/or infrared (IR) light (˜700 nm−1 mm in wavelength). These wavelengths take advantage of the relatively low cost attributable to those types of LEDs. For example, the light source 94 may be configured to emit blue light consistent with other lighting throughout the vehicle 54. Furthermore, the light source 94 may include a housing, one or more reflectors, a heat sink, or any other component to facilitate production of the excitation light 24 without departing from the scope of the present disclosure.

The lock cylinder 74 may be generally formed of a metallic alloy that may be generally reflective. Specifically, the alloy may be selected to reflect about 70% of light that contacts a surface of the alloy. Where the channel wall 168 is defined by the lock cylinder 74, as discussed previously, the channel wall 168 may be formed of the alloy and may be configured to transmit the excitation light 24 from the light source 94 through the channel 82. Where the channel wall 168 is defined by the light guide 170, as discussed previously, the channel wall 168 may be formed of or coated with a reflective material configured to transmit the excitation light 24 from the light source 94 through the light guide 170 and channel 82. Regardless of the material used to form the channel wall 168, the channel wall 168 may be configured to direct the excitation light 24 from the light source 94 through the slot 78 at the first end 86 of the channel 82 and outward of the lock cylinder 74.

Referring now to FIG. 3B, the switch door 90 may be operably coupled with the lock cylinder 74, as introduced above. The switch door 90 may be hingedly coupled with the lock cylinder 74 at the end face 154. The switch door 90 may be positioned at least partially within the slot 78. Alternatively, the switch door 90 may be positioned exterior of the slot 78 and may be coupled with the end face 154. As shown in the illustrated embodiment, the switch door 90 is positioned to cover the slot 78. The switch door 90 is movable between an open position and a closed position. When the switch door 90 is in the closed position, the switch door 90 is positioned to cover the first end 86 of the channel 82 and/or the slot 78. The switch door 90 may be movable from the closed position to the open position to allow access to the channel 82 of the lock cylinder 74. Specifically, the switch door 90 may be moved from the closed position to the open position by the key shaft 66 of the key 58 when the key shaft 66 is at least partially received by the slot 78 and the channel 82, as discussed elsewhere herein.

The switch door 90 may be formed of a polymeric material. The polymer material may be selected such that the switch door 90 is transparent, semi-transparent, or opaque. For example, the polymeric material may be selected to give the switch door 90 a clear or milky appearance. Furthermore, the switch door 90 may be configured to direct the excitation light 24 from the light source 94 outward of the lock cylinder 74 when the switch door 90 is in the closed position. In other words, the switch door 90 may include optics to direct the excitation light 24 from the light source 94 outward of the lock cylinder 74. The switch door 90 may further be configured to protect the channel 82 of the lock cylinder 74 from exposure to or damage from debris.

Referring now to FIG. 4, the key 58 may be provided including the key head 62 and the key shaft 66. The key head 62 may be configured as a grip for the key 58. The key shaft 66 may extend from the key head 62 and may be configured to be at least partially received by the slot 78 and/or channel 82 of the lock cylinder 74. The key shaft 66 may include an outer edge 174 and may define at least one recess 70. The shape of the outer edge 174 of the key shaft 66 and the positioning, size, and shape of the at least one recess 70 may be selected based on the lock cylinder 74 configured to be coupled with the key 58. For example, the key shaft 66 may have a plurality of recesses 70 extending along the length of the key shaft 66, or the key shaft 66 may have a single recess 70 extending along the key shaft 66. It will be understood that the configuration of the key shaft 66, including the outer edge 174 and the at least one recess 70, illustrated in the disclosure is exemplary only and that the configuration of the key shaft 66 may be unique to each individual key 58 without departing from the scope of the present disclosure.

The key shaft 66 and/or the key head 62 may each include indicia 178. The indicia 178 may be letters, numbers, images, logos, and/or any other stylized mark. The indicia 178 may be configured to be recessed from a surface of the key shaft 66 or the key head 62, or the indicia 178 may be etched into the surface of the key shaft 66 or key head 62. The indicia 178 may further be configured to protrude outward from the surface of the key shaft 66 or the key head 62. For example, the key shaft 66 may include indicia 178 etched into the surface of the key shaft 66, and the key head 62 may include indicia 178 protruding from the key head 62, as illustrated in FIG. 4.

As discussed above, the luminescent structure 10 may be used in conjunction with the lock assembly 50. Specifically, the luminescent structure 10 may be positioned on the outer edge 174 of the key shaft 66 of the key 58, on the indicia 178, within the recess 70 of the key shaft 66 of the key 58, or on any other surface of the key 58. In some examples, the luminescent structure 10 may be pad printed onto the key 58. It is also contemplated that the luminescent structure 10 may be positioned proximate the lock cylinder 74 without departing from the scope of the present disclosure. The luminescent structure 10 is configured to luminescent response excitation light 24 from the light source 94 such that the key 58 becomes more visible, as discussed in more detail elsewhere herein.

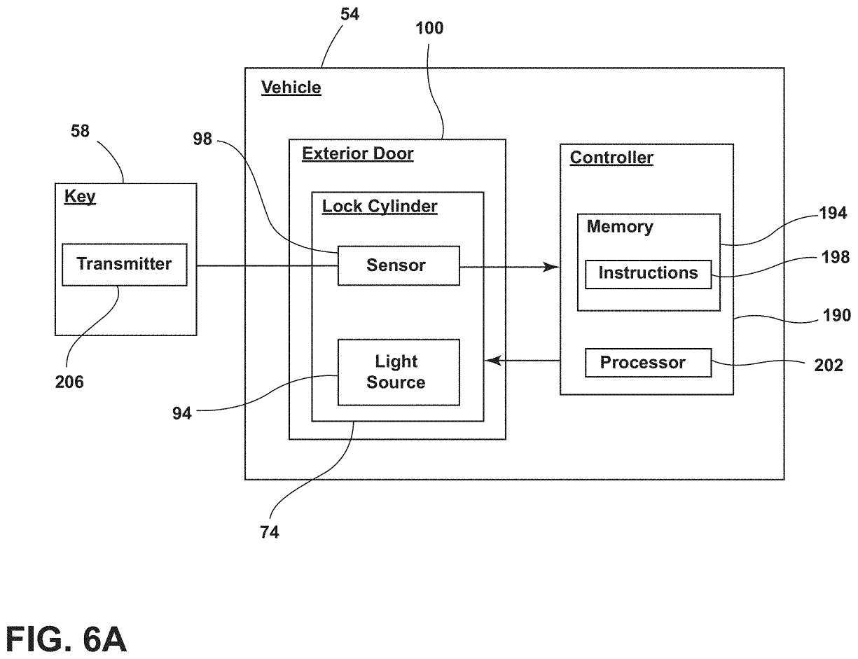

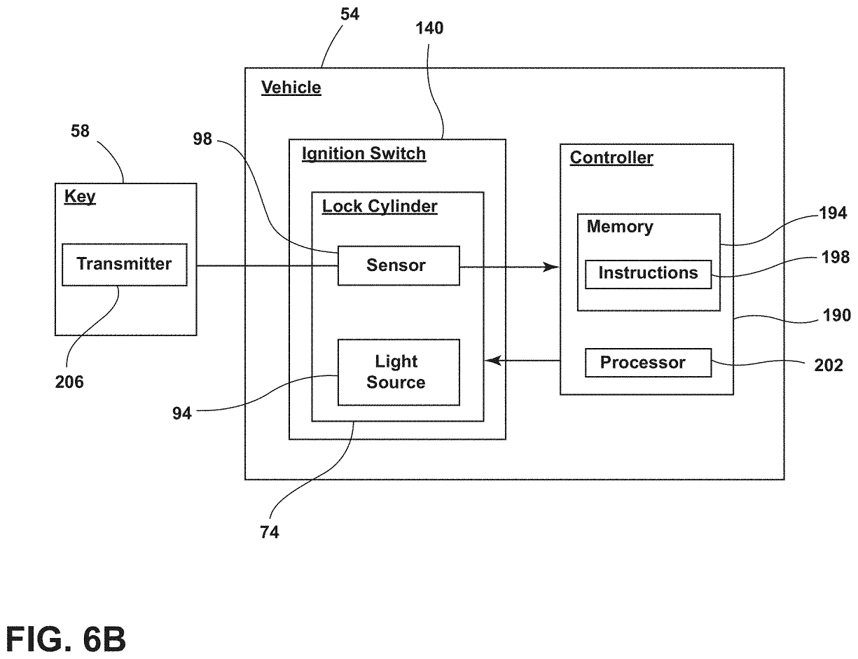

Referring now to FIGS. 5A-6B, the light source 94 may be operably coupled with a controller 190. The light source 94 may be controlled by a standalone controller or may be otherwise integrated with an existing vehicle system. The controller 190 includes a memory 194 having instructions 198 stored thereon that are executable by a processor 202. The instructions 198 may generally relate to ways in which to operate the light source 94 to affect the intensity of the excitation light 24 emitted by the light source 94 through the slot 78 and/or channel 82. In other words, the intensity of the excitation light 24 emitted from the light source 94 may be selected from one or more intensities.

As introduced above, the sensor 98 may be coupled with the lock cylinder 74 and may further be operably coupled with the light source 94. The sensor 98 may be configured to communicate with a transmitter 206 positioned within the key 58. The transmitter 206 is identifiable by a unique frequency match to enable the key 58 to transmit signals to the sensor 98 which are recognized by the sensor 98, such that the sensor 98 may detect the presence of the key 58 through communication with the transmitter 206. The sensor 98 may be further configured to detect the location of the key 58 and determine the distance between the key 58 and the lock cylinder 74. The sensor 98 may be electrically coupled with the controller 190 and may be configured to provide input to the controller 190 for the selection of the instructions 198 by the processor 202 based on the location of the key 58. In other words, the intensity of the excitation light 24 emitted from the light source 94 and/or the operation of the light source 94 may be selected from one or more intensities based on the detected distance between the key 58 and the sensor 98 as determined by the sensor 98 through communication with the transmitter 206.

The sensor 98 may be configured to detect the key 58 at a predetermined distance from the lock cylinder 74 (e.g., about two inches to about eight inches, about three inches to about six inches, or any value or range of values therebetween). For example, the sensor 98 may be configured to detect the key 58 when the key 58 is within about two inches, about three inches, about four inches, about five inches, about six inches, about seven inches, or about eight inches. In various examples, the light source 94 may be the configured to emit excitation light 24 at one or more intensities. As the distance between the key 58 and the lock cylinder 74 is decreased, the intensity of the excitation light 24 may be increased. For example, the light source 94 may emit excitation light 24 at a first intensity when the key 58 is about six inches from the lock cylinder 74, a second intensity when the key 58 is about five inches from the lock cylinder 74, and so forth until the key 58 is received by the slot 78 and/or the channel 82 of the lock cylinder 74.

The key 58 is moved in the direction of the lock cylinder 74 and/or the surrounding features of the vehicle (e.g., the exterior door 100 (FIG. 6A) or the ignition switch 140 (FIG. 6B). As the key 58 is moved proximate the lock cylinder 74, the light source 94 may be illuminated. The emitted excitation light 24 from the slot 78 and channel 82 is configured to increase the visibility of the lock cylinder 74 as the key 58 moves closer to the lock cylinder 74. As the excitation light 24 is directed outward of the lock cylinder 74, the excitation light 24 excites the luminescent structure 10 coupled with the key 58. The luminescent structure 10 gathers the excitation light 24 and re-emits the light as converted light 26. Advantageously, this increases the efficiency of the light source 94 for illuminating the key 58 and increases the visibility of the key 58 as the key 58 moves closer to the lock cylinder 74. The increase in the intensity of the excitation light 24 further advantageously creates a feedback loop for an occupant as the occupant moves the key 58 toward the lock cylinder 74.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A lock assembly for use in a vehicle, comprising:
a key including a key head and a key shaft, the key shaft defining a recess;
a lock cylinder defining a slot and a channel, the slot in communication with a first end of the channel;
a switch door positioned to cover the slot;
a light source positioned at a second end of the channel and positioned to illuminate through the channel;
a sensor configured to detect the key, the sensor coupled with the light source and configured to actuate the light source based on a location of the key; and
a luminescent structure positioned on the key shaft within the recess.

2. The lock assembly of claim 1, wherein the switch door is at least partially translucent.

3. The lock assembly of claim 1, wherein the luminescent structure is positioned on an edge of the key shaft.

4. The lock assembly of claim 1, wherein the light source is configured to emit light at one or more intensities in response to activation of the sensor.

5. The lock assembly of claim 1, wherein the luminescent structure is configured to luminesce in response to excitation by the light source.

6. A lock assembly, comprising:
a lock cylinder operably coupled with a vehicle and defining a channel, the channel having a first end, wherein the first end is open;
a key configured to be at least partially received by the channel;
a light source positioned at a second end of the channel, the second end opposite the first end, wherein the light source is configured to illuminate through the channel;
a sensor coupled with the light source and configured to actuate the light source based on a location of the key; and
a luminescent structure positioned on the key, the luminescent structure configured to luminesce in response to excitation by the light source.

7. The lock assembly of claim 6, wherein the key includes a key shaft defining a recess, and further wherein the luminescent structure is positioned within the recess.

8. The lock assembly of claim 6, wherein the key includes indicia, and further wherein the luminescent structure is positioned on the indicia.

9. The lock assembly of claim 6, further comprising:
a switch door positioned over the first end of the channel.

10. The lock assembly of claim 6, wherein the lock cylinder is operably coupled with an ignition switch.

11. The lock assembly of claim 6, wherein the lock cylinder is operably coupled with an exterior door of the vehicle.

12. The lock assembly of claim 6, wherein the sensor is configured to increase illumination of the light source as the key is moved proximate the lock cylinder.

13. The lock assembly of claim 6, wherein the luminescent structure is pad printed onto the key.

14. A lock assembly, comprising:
a key defining a recess;
a lock cylinder operably coupled with a vehicle, the lock cylinder defining a channel having first and second ends, the channel configured to at least partially receive the key;
a light source positioned at the second end of the channel and configured to illuminate through the channel; and
a sensor configured to detect the key, the sensor configured to actuate the light source based on a location of the key.

15. The lock assembly of claim 14, further comprising:
a switch door positioned over the first end of the channel, the first end opposite the second end of the channel.

16. The lock assembly of claim 15, wherein the switch door is translucent, and further wherein excitation light from the light source is directed through the switch door.

17. The lock assembly of claim 14, further comprising:
a luminescent structure positioned with the recess of the key, the luminescent structure configured to luminesce in response to excitation by the light source.

18. The lock assembly of claim 17, wherein the key includes indicia, and further wherein the luminescent structure is positioned on the indicia.

19. The lock assembly of claim 14, wherein the light source is configured to emit light at one or more intensities in response to activation of the sensor.

20. The lock assembly of claim 19, wherein an intensity is selected from the one or more intensities based on a distance between the key and the sensor.
